(19) United States
(12) Patent Application Publication
(10) Pub. No.: US 2025/0033251 A1
(43) Pub. Date: Jan. 30, 2025

(54) Producing tactile gelatin objects of a wide variety of shapes

(71) Applicant: Leah Minsky, Pittsburgh, PA (US)

(72) Inventor: Leah Minsky, Pittsburgh, PA (US)

(21) Appl. No.: 18/445,356

(22) Filed: Jul. 27, 2023

(51) Int. Cl. B29C 39/00; B29C 39/02; B29C 39/26; B29C 39/38

(52) U.S. Cl. CPC B29C 39/003; B29C 39/02; B29C 39/26; B29C 39/38; B29C 33/60; B29K 2089/00; B29K 2883/00

(57) ABSTRACT

An artistic or utilitarian (as opposed to ingestible) object with a desirable tactile sensation and a soft, yet firm, transparent texture is produced from more than 250 bloom gelatin (e. g. 300 bloom gelatin). The method includes producing a thin positive silicone mold corresponding to an artistic or utilitarian three-dimensional object to be produced; then pouring a mixture of water, dye, and more than 250 bloom gelatin into the positive silicone mold; refrigerating the gelatin mixture for a time and at a temperature sufficient for it to harden into an artistic or utilitarian three-dimensional gelatin object; and then demolding the object.

### BACKGROUND AND SUMMARY OF THE INVENTION

There are many times when it is desirable to produce artistic or utilitarian (as opposed to ingestible) three-dimensional objects with complex shapes. This is true for art objects, models used to demonstrate various body parts or mechanical devices, or simulations of products of nature. According to the invention a method is provided which allows simple production of such three-dimensional objects in such a way that their structures are limited only by the imagination of the artisan or other skilled worker, but the objects produced have a unique tactile sensation. Although an object produced according to the invention has a unique tactile sensation it still has sufficient rigidity to stand on its own and often the surface has tiny smooth grooves and dimples which also provide a desirable feature.

The main, or sometimes the only, material used to produce objects according to the method of the invention is a high bloom gelatin powder in water. Present commercially available gelatin has a bloom of between about 90 and 300, the higher the bloom the higher the rigidity of objects produced thereby. Gelatin used in food typically has a bloom of about 125, but can be as high as 250. According to the invention the gelatin utilized has a bloom of more than 250, preferably about 300. The objects produced according to the invention are artistic or utilitarian as opposed to ingestible objects, and the invention does not relate to the production of ingestibles.

While sometimes other materials can be added to the gelatin typically the material used to make the objects according to the invention consists essentially of gelatin with a bloom over 250, or consists essentially of 300 bloom gelatin and a dye, which preferably but not necessarily is a food grade dye even though the object is not intended to be consumed but rather to serve as a piece of art or a model of a three-dimensional object like a body part, mechanical structure, or product of nature.

In its most basic form the method of the invention comprises or consists essentially of producing a three-dimensional artistic or utilitarian object by: a) producing a thin positive silicone mold corresponding to a three-dimensional artistic or utilitarian object to be produced; b) pouring a mixture of water and more than 250 bloom gelatin into the positive silicone mold; c) refrigerating the gelatin mixture for a time and at a temperature sufficient for it to harden into an artistic or utilitarian three-dimensional object; and d) demolding the three-dimensional artistic or utilitarian object.

Element a) of the method is preferably practiced by creating an initial positive mold form such as by 3D printing or sculpting with clay. The 3D form may be created using HOUDINI software and may be 3D printed using polylactic acid (PLA). If sculpting with clay a sulfur-free clay is preferably employed. The initial positive mold form is desirably placed on a flat surface. Element a) preferably further comprises utilizing a silicone rubber which is brushed onto the initial form. Most desirably an easy to use platinum-cure silicone rubber such as Rebound 25 is utilized. Components A and B of Rebound 25 are typically mixed in about a 1:1 ratio and the material self-thickens so that it may be easily applied with a brush or spatula to even vertical surfaces without sagging and with negligible shrinkage. It is desirable to remove air bubbles from the Rebound 25 mixture which can be accomplished by placing it in a vacuum pressure chamber.

Procedure a) is further practiced by applying the silicone with air bubbles removed to the mold form typically by brushing. Desirably a plurality of layers of silicone are applied with a brush, letting each layer cure before the next is added, to produce a thin silicone mold. The silicone mold is preferably two-five layers thick, most desirably three layers thick.

In order to provide support for the thin silicone mold there is a further procedure a1) before b), of creating a two part support shell. The support shell is preferably made of plaster using conventional techniques, e.g. by using gypsum plaster bandages. Before b) there is the procedure a2) of demolding the initial positive mold from the silicone mold and support shell. Finally, ensuring that the support shell encompasses the silicone mold there is also desirably the procedure a3), before b), of spraying release oil on the inside of the silicone mold to facilitate ultimate release of a three-dimensional object from the silicone mold.

Element b) is practiced by turning the silicone mold “upside down” so that the open area thereof is at the top. A procedure b1) comprises making a mixture of more than 250 bloom gelatin and cold water. For example three tablespoons of Superclear Powder 300 Bloom Food Grade Gelatin is mixed with one cup of cold water. Once the gelatin has absorbed the cold water then b2) two cups of hot water is added to the mixture. Optionally, but desirably, b3) dye, such as conventional food dye, is added to the mixture to obtain the desired color. Alternatively other additives may also be provided in the mixture, but are not typically necessary and the mixture will typically consist essentially of gelatin and water, or consist essentially of gelatin, dye, and water. Once the mixture is made typically using the container in which it is mixed, such as a conventional large measuring cup, the mixture is poured into the open top of the silicone mold.

Element c) may be practiced in a conventional commercial or residential refrigerator and the time necessary to set will depend upon what the temperature in the refrigerator is and the volume of the object being produced. Sometimes if the temperature is low, e. g. 34-38° F., and the volume is small it can set in as little as two-four hours, however desirably the gelatin in the mold is allowed to sit in the refrigerator overnight to insure complete setting.

Element d) is preferably practiced by insuring that the thin silicone mold is separate from the support shell, and then shimming it, or after turning the silicone mold right side up pulling on the bottom lip in opposite directions and turning the mold while doing that until the gelatin artistic or utilitarian object comes out.

The gelatin cast/three-dimensional artistic or utilitarian object produced according to a)-d) has a unique tactile sensation that in some cases is of equal importance to its visual sensation. The three-dimensional object produced may also have tiny grooves and dimples which enhance the tactile sensation. Examples of three-dimensional objects that can be produced according to the invention are art objects, models of body parts, models of mechanical devices, and simulations of natural products such as tree branches, rocks, animals, and insects.

It is the primary object of the present invention to simply produce three-dimensional artistic and utilitarian objects of a wide variety of types using a simple readily obtained material that does not require heating to high temperatures and where the final object has a very desirable tactile sensation. This and other objects of the invention will become clear from the detailed description of the invention and from the appended claims.

### BRIEF DESCRIPTION OF THE DRAWINGS

FIG. 1 is a flow chart illustrating the elements of an exemplary procedure for practicing the invention and producing a three-dimensional object;

FIG. 2 is a schematic perspective view of an exemplary thin silicone mold utilized in the practice of the invention and partially showing in dotted line and partly in cross-section a two part support shell surrounding the mold when a gelatin mixture is poured into the open top thereof;

FIG. 3 is a schematic representation of an exemplary manner of shimming the silicone mold after the gelatin object is fully formed so as to release the object from the silicone mold, part of the mold cut away to illustrate the gelatin object therein;

FIG. 4 is a schematic perspective view of an exemplary three-dimensional art object produced according to the invention after demolding in FIG. 3, the object having a desirable tactile feel;

FIG. 5 is a schematic side view of an exemplary model of a human body part (brain) as the object produced according to the invention; and

FIG. 6 is a side view of an exemplary natural object (duck) produced according to the present invention.

### DETAILED DESCRIPTION OF THE DRAWINGS

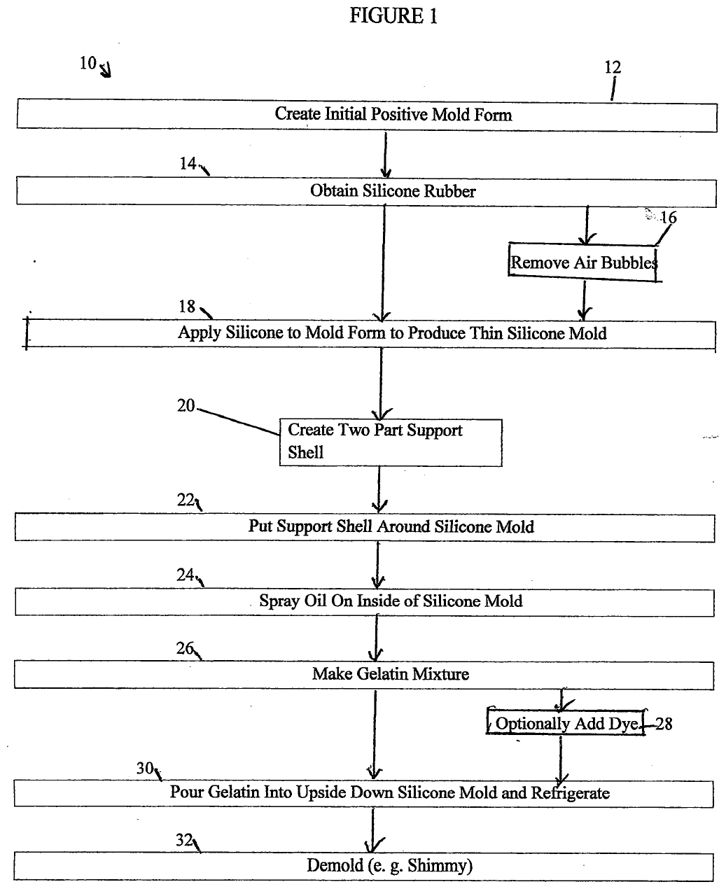

FIG. 1 shows in flow chart form an exemplary method 10 according to the present invention for producing a three-dimensional artistic or utilitarian object that has a desirable tactile feel in addition to sufficient structural integrity so as to be used as an art object, model of a body part, model of a mechanical device, or simulation of a natural product such as a tree branch, rock, animal, or insect.

The first element of the method 10 is the creation of an initial positive mold form as illustrated at 12. While 12 can be accomplished in a number of different manners the most desirable are 3D printing and clay sculpting. The 3D form may be created using HOUDINI software and may be 3D printed using polylactic acid (PLA). If sculpting with clay a sulfur-free clay is preferably employed using conventional techniques.

The next element of the method 10 is obtaining a suitable silicone rubber, as illustrated at 14 in FIG. 1. Most desirably an easy to use platinum-cure silicone rubber such as Rebound 25 is utilized. Components A and B of Rebound 25 are typically mixed in about a 1:1 ratio and the material self-thickens so that it may be easily applied with a brush or spatula to even vertical surfaces without sagging and with negligible shrinkage.

Although not completely necessary for all objects it is usually desirable to remove air bubbles from the Rebound 25 mixture, as illustrated at 16 in FIG. 1, which can be accomplished by placing it in a vacuum pressure chamber.

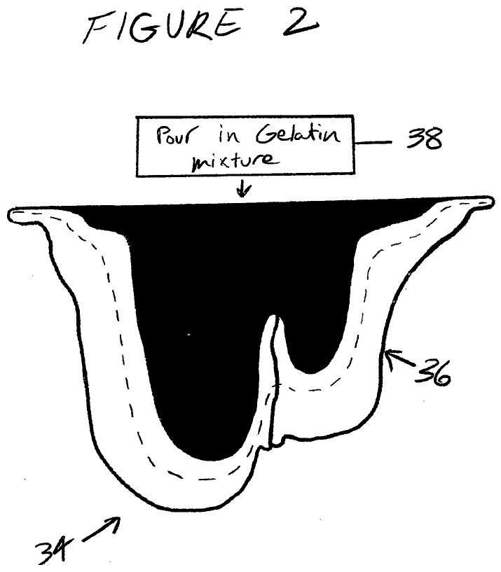

The next element of the method 10 is to apply the silicone to the mold form to produce a thin silicone mold, as illustrated at 18 in FIG. 1. The silicone with air bubbles removed is preferably applied to the mold form in layers typically by using a brush. Desirably a plurality of layers of silicone are applied with the brush, letting each layer cure before the next is added, to produce a thin silicone mold (34 in FIGS. 2 & 3). The thin silicone mold (34) is preferably two-five layers thick, most desirably three layers thick.

The next element of the method 10 is to create a support shell (36 in FIG. 2) for the thin (e. g. three brush-applied layers thick) silicone mold. This is illustrated at 20 in FIG. 1. The support shell 36 is in two parts that may be easily fit together and moved apart, and is preferably made of plaster using conventional techniques, e. g. by using gypsum plaster bandages. Once constructed the support shell is placed around the thin silicone mold as indicated at 22 in FIG. 1 (and as schematically indicated at 34/36 in FIG. 2). The silicone mold 34 and support shell 36 are demolded from the initial positive mold form (not illustrated in FIG. 1) and then preferably a suitable oil (such as silicone, mineral, or vegetable oil) is sprayed onto the interior of the silicone mold 34 as indicated at 24 in FIG. 1 to facilitate ultimate release of the object being produced.

As indicated at 26 in FIG. 1 a gelatin mixture is made either before, during, or after 24. Procedure 26 typically comprises or consists of initially making a mixture of more than 250 bloom gelatin and cold water. For example three tablespoons of Superclear Powder 300 Bloom Food Grade Gelatin is mixed with one cup of cold water, or like proportions for larger or smaller objects. Once the gelatin has absorbed the cold water then two cups of hot water is added to the mixture which then has a desirable temperature of typically about 120-140° F.

Optionally, but desirably, dye, such as conventional food dye, is added to the mixture as indicated at 28 in FIG. 1 to obtain the desired color of the gelatin. Alternatively small amounts (typically less than 2% by volume) of other additives may also be provided in the mixture, but are not typically necessary and the mixture will typically consist essentially of gelatin and water, or consist essentially of gelatin, dye, and water.

Once the gelatin mixture is made typically using the container in which it is mixed, such as a conventional large measuring cup, as indicated at 30 in FIG. 1 the mixture is poured into the open top of the silicone mold 34 (typically, but not necessarily, with the support shell 36), as illustrated schematically at 38 in FIG. 2, and the mold 34 is placed in a conventional commercial or residential refrigerator (also indicated at 30 in FIG. 1). The time in the refrigerator necessary to set the gelatin will depend upon what the temperature is in the refrigerator and the volume of the object being produced. Sometimes if the temperature is low, e. g. 34-38° F., and the volume is small it can set in as little as two-four hours; however desirably the gelatin in the mold 34 is allowed to sit in the refrigerator overnight to insure complete setting.

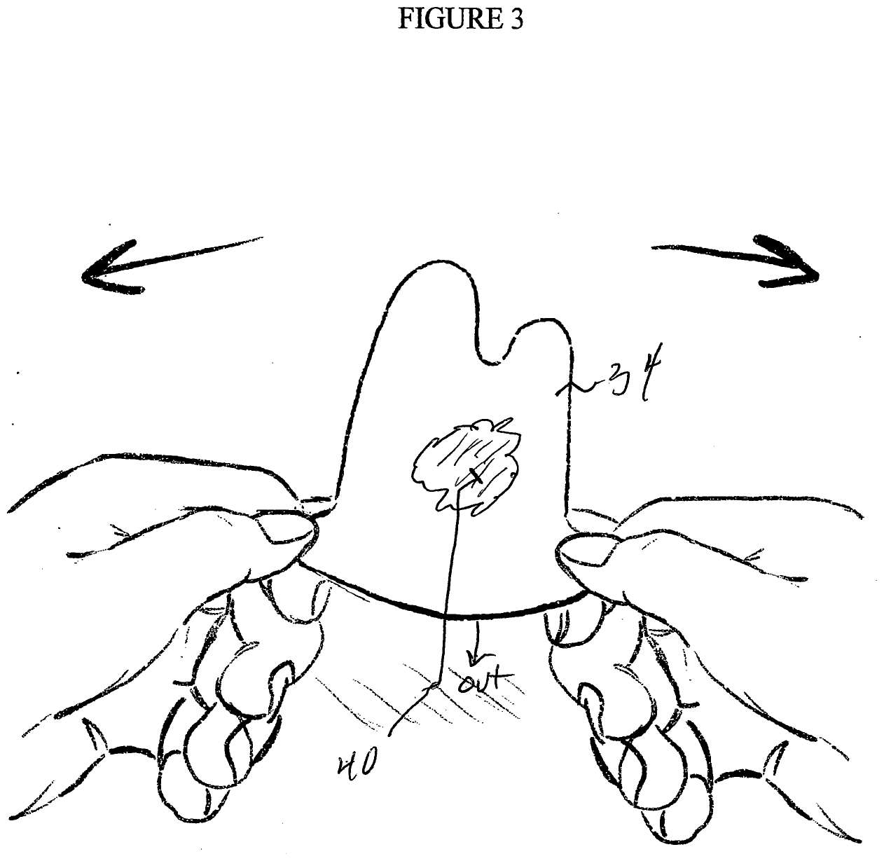

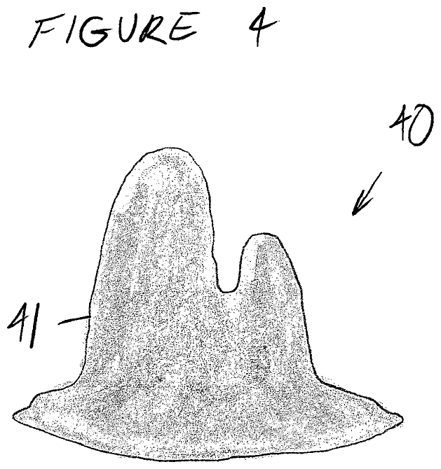

Once the gelatin has completely set the method 10 is preferably practiced by insuring that the thin silicone mold 34 is separate from the support shell 36, and then shimming the mold 34 as indicated at 32 in FIG. 1 and as schematically illustrated in FIG. 3. As an alternative to, or in addition to, shimming demolding as indicated at 32 is practiced after turning the silicone mold 34 right side up, pulling on the bottom lip in opposite directions, and turning the mold 34 while doing that until the gelatin cast/object (e. g. 40 in FIGS. 3 and 4) comes out.

FIG. 4 is an illustration of an exemplary art object 40 produced according to the method 10 of the present invention after demolding in FIG. 3. The surface 41 of the art object 40 has a very desirable tactile sensation while the object 40 maintains structural integrity; the object 40 has a soft, yet firm, transparent texture. The surface 41 may also have tiny grooves and dimples (not visible in the drawings).

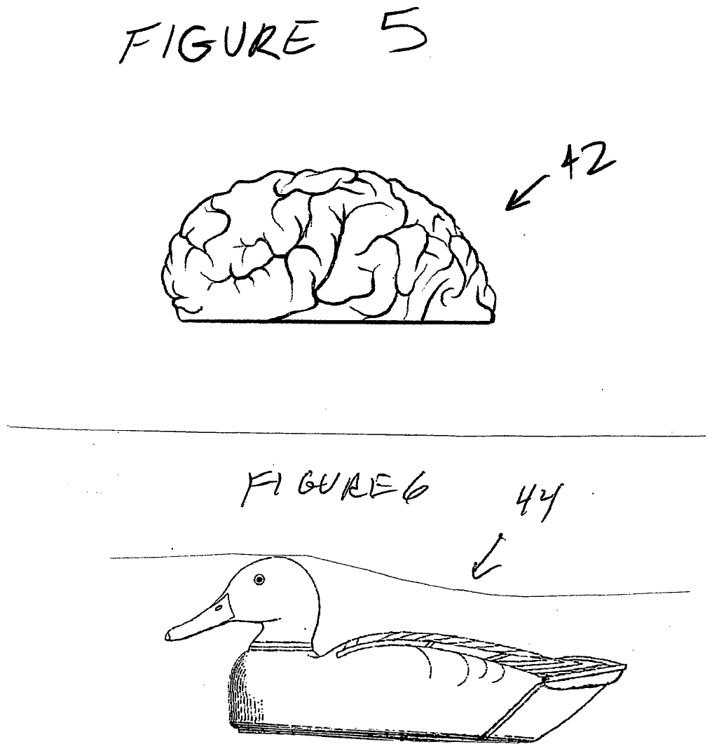

FIGS. 5 and 6 schematically illustrate other types of objects that can be made using the method 10 according to the invention. FIG. 5 provides a schematic side view of an exemplary model of a human body part, in this case a brain, as the object 42 produced according to the invention. FIG. 6 provides a side view of an exemplary natural object, in this case a duck, as the object 44 produced according to the present invention. The utilitarian objects 42, 44 also have the desirable tactile sensation of the invention.

While the invention has been herein shown and described in what is presently considered to be a practical and preferred embodiment it is to be understood that many modifications may be made within the scope of the invention to cover all equivalent structures and procedures, limited only by the appended claims and the prior art.

What is claimed is:

1. A method of producing an artistic or utilitarian three-dimensional object comprising: a) producing a thin positive silicone mold corresponding to an artistic or utilitarian three-dimensional object to be produced; b) pouring a mixture of water and more than 250 bloom gelatin into the positive silicone mold; c) refrigerating the gelatin mixture for a time sufficient for it to harden into an artistic or utilitarian three-dimensional object; and d) demolding the three-dimensional gelatin artistic or utilitarian object.

2. The method of claim 1 consisting essentially of a)-d).

3. The method of claim 1 wherein a) is practiced by creating an initial positive mold form by 3D printing or sculpting with clay.

4. The method of claim 3 wherein a) further comprises utilizing a self-thickening silicone rubber which can be applied by a brush onto the initial form.

5. The method of claim 4 further comprising removing air bubbles from the silicone rubber.

6. The method of claim 5 wherein a) is further practiced by brushing the silicone with air bubbles removed onto the mold form in a plurality of layers and letting each layer cure before the next is added, to produce a thin silicone mold.

7. The method of claim 6 wherein a) is further practiced to provide a thin silicone mold two-five layers thick.

8. The method of claim 6 further comprising a1), before b), creating a two part support shell for the silicone mold and providing the support shell around the silicone mold.

9. The method of claim 8 further comprising a2), before b), of demolding the initial positive mold from the silicone mold and support shell.

10. The method of claim 9 further comprising a3), before b) and after a2), spraying mold release oil onto the inside surface of the silicone mold to facilitate ultimate release of a three-dimensional object from the silicone mold.

11. The method of claim 10 wherein b) is practiced by turning the silicone mold upside down so that the open area thereof is at the top and further comprising b1) making a mixture of more than 250 bloom gelatin and cold water and once the gelatin has absorbed the cold water adding hot water to the mixture so that the gelatin is completely dissolved in the water; and then b2) pouring the gelatin completely dissolved in water into the open top of the silicone mold.

12. The method of claim 11 further comprising b3), before b2), adding dye to the mixture to obtain the desired color.

13. The method of claim 12 wherein.b2) and b3) are practiced so that the mixture consists essentially of gelatin, dye, and water.

14. The method of claim 11 wherein c) is practiced by placing the silicone mold with gelatin mixture in a conventional commercial or residential refrigerator for a sufficient time and at a sufficient temperature so that the gelatin completely sets to produce the desired object.

15. The method of claim 14 wherein d) is practiced by insuring that the thin silicone mold is separate from the support shell, and then practicing at least one of shimming the silicone mold, and after turning the silicone mold right side up pulling on the bottom lip in opposite directions and turning the mold, until the gelatin object is released from the mold.

16. A method as recited in claim 11 wherein b1) is practiced using about 300 bloom gelatin.

17. A method as recited in claim 1 wherein a)-d) are practiced to produce an artistic or utilitarian gelatin object that has a desirable tactile sensation and a soft, yet firm, transparent texture.

18. An artistic or utilitarian gelatin object produced by the method of claim 16 with a desirable tactile sensation and a soft, yet firm, transparent texture.

19. A method of producing an artistic or utilitarian three-dimensional object comprising: a) producing a thin positive silicone mold corresponding to an artistic or utilitarian three-dimensional object to be produced; b) pouring a mixture consisting essentially of water, dye, and about 300 bloom gelatin into the positive silicone mold; c) refrigerating the gelatin mixture for a time and at a temperature sufficient for it to set into a three-dimensional artistic or utilitarian object; and d) demolding the three-dimensional gelatin artistic or utilitarian object

20. An artistic or utilitarian gelatin object produced by the method of claim 19 with a desirable tactile sensation and a soft, yet firm, transparent texture.
